(19) United States
(12) Patent Application Publication
(10) Pub. No.: US 2008/0041813 A1
(43) Pub. Date: Feb. 21, 2008

(54) METHODS AND COMPOSITIONS FOR WET ETCHING

(75) Inventors: Isaiah Olatunde Oladeji, Gotha, FL (US); Alan Cuthbertson, Newcastle upon Tyne (GB)

Correspondence Address: FISH & RICHARDSON P.C., PO BOX 1022, MINNEAPOLIS, MN, 55440-1022, US

(73) Assignee: ATMEL CORPORATION, San Jose, CA (US)

(21) Appl. No.: 11/618,240

(22) Filed: Dec. 29, 2006

Related U.S. Application Data
(60) Provisional application No. 60/839,349, filed on Aug. 21, 2006.

(51) Int. Cl. H01B 13/00; C09K 13/00

(52) U.S. Cl. 216/13; 252/79.1

(57) ABSTRACT

A composition comprising an aqueous solution of: a wet-etch formulation that is proven to etch copper; and a wetting agent. Exemplary wet-etch formulations include a mixture of a strong inorganic acid, such as sulfuric acid or hydrofluoric acid, and an oxidizing agent such as hydrogen peroxide, and further include ammonium persulfate. Exemplary wetting agents include organic acids such as citric acid, acetic acid, oxalic acid, or formic acid. Processes of using the compositions for wet-etching, or chemical mechanical polishing, or fabricating thick copper inductors, are further provided.

### CROSS-REFERENCE TO RELATED APPLICATION

This application claims the benefit of priority under 35 U.S.C. § 119(e) to U.S. provisional application Ser. No. 60/839,349, filed Aug. 21, 2006, which is incorporated herein by reference in its entirety.

### FIELD OF THE INVENTION

The present invention generally relates to a method and composition having an application to wet etching.

### BACKGROUND

Copper (Cu) finds widespread use in the manufacture of semiconductor devices, for example, as interconnects, on account of its high conductivity and ease of processing. Two methods of forming patterned copper conductors with fine linewidth are widely used. In the so-called Damascene process, a layer of copper is deposited onto a substrate having etched channels so that copper fills the channels; excess copper is removed in a chemical mechanical polishing (planarization) step that ensures that the copper in the channels is level with the substrate surface. In through-mask plating, a seed layer of conductor is deposited. A mask layer is superposed on the seed layer and electroplating is used to deposit copper on the seed layer in the areas not covered by the mask. Subsequently, both the mask and the seed, around the copper, are removed in a procedure known as wet-etching. (For a review of processing technologies, see, e.g., “Damascene copper electroplating for chip interconnections,” P. C. Andricacos, et al., IBM Journal of Research and Development, Vol. 42, No. 5, (1998), Electrochemical Microfabrication.) Therefore, a vital step in device manufacture is the removal of superfluous copper layers in a manner that is not injurious to the device's critical copper circuitry. Removal is typically performed by controlled application of a liquid composition that attacks the exposed copper metal.

As copper structures get smaller and smaller, it is becoming increasingly difficult to etch unwanted copper seed in open areas and in between the desired intricate Cu structures uniformly, without undercut, and without destroying the copper structure profile. This is in large part due to the poor wetting ability of the copper wet-etch chemistry currently available on the market. Thus, the drawbacks of wet-etching are already a significant issue in manufacturing processes where through mask Cu plating is used.

Currently, this problem is addressed with much longer than desirable copper wet etching times, using compositions such as sulfuric acid (H₂SO₄) plus hydrogen peroxide (H₂O₂), or hydrofluoric acid (HF) plus H₂O₂, or ammonium persulfate ((NH₄)₂S₂O₈). To mediate the impact of this longer etch time, a higher copper line critical dimension (CD) bias is put in place and a much thicker copper line than the required target thickness is plated. (CD bias represents the CD loss due to intentional photoresist trimming.) These precautions are to ensure that after Cu seed wet etch and Cu barrier removal, the Cu line profile has no intra-line leakage current and is still suitable for the required application.

The discussion of the background to the invention herein is included to explain the context of the invention. This is not to be taken as an admission that any of the material referred to was published, known, or part of the common general knowledge as at the priority date of any of the claims. Throughout the description and claims of the specification the word “comprise” and variations thereof, such as “comprising” and “comprises”, is not intended to exclude other additives, components, integers or steps.

### SUMMARY OF THE INVENTION

In overview, in one aspect a composition is provided that is capable of etching a blanket copper (Cu) film in a uniform manner, or efficiently removing the portion of the film which is not part of a desired intricate conductive structure, while avoiding undercut or over-etching of the structure.

In one implementation, the composition includes: (1) sulfuric acid (H₂SO₄), hydrogen peroxide (H₂O₂), and a wetting agent (acetic acid, citric acid or another compound containing a carboxylic acid group) in an appropriate ratio; or (2) hydrofluoric acid (HF) plus hydrogen peroxide, with a wetting agent (acetic acid, citric acid or another compound containing a carboxylic acid group) in an appropriate ratio; or (3) ammonium persulfate ((NH₄)₂S₂O₈) with a wetting agent (acetic acid, citric acid, or another compound containing a carboxylic acid group).

In one aspect the composition comprises a solution including substantially 2.6 to 6% weight of the wet-etch formulation that is proven to etch copper and a wetting agent, wherein the solution comprises substantially 3 to 10% weight of the wetting agent.

In another aspect, the composition comprises an aqueous solution including substantially 2.6 to 6% weight of a wet-etch formulation that is proven to etch copper and substantially 0.6 to 10% by weight of a wetting agent selected from the group consisting of: citric acid, acetic acid, oxalic acid, and formic acid.

In yet another aspect, the composition consists of an aqueous solution of substantially 2.6 to 6% weight of a wet-etch formulation that is proven to etch copper; and substantially 0.6 to 10% by weight of a wetting agent selected from the group consisting of: citric acid, acetic acid, oxalic acid, and formic acid.

In another aspect a process is provided for depositing a copper interconnect in a semiconducting device, using a composition as described above as either a wet-etching agent, or in chemical mechanical polishing (CMP). The compositions can also be deployed for subtractive patterning of deposited Cu films for metal-insulator-metal (MIM) and flat panel display Cu electrodes, as well as for fabricating thick copper inductors.

In another aspect, a method of wet-etching copper conductors is described that comprises applying an aqueous etching solution to a surface comprising copper, wherein the aqueous etching solution comprises 2.6 to 6% weight of a wet-etch formulation that is proven to etch copper and 0.6 to 10% weight of a wetting agent.

In yet another aspect, a method is provided for fabricating a copper inductor. A copper seed layer is formed on a substrate. A mask is formed on the seed layer. A layer of copper is applied to form an array of copper interconnects. Portions of the copper seed layer are removed from between the copper interconnects, wherein the removing step comprises applying an aqueous etching solution to a surface comprising copper, wherein the aqueous etching solution comprises 2.6 to 6% weight of a wet-etch formulation that is proven to etch copper and 0.6 to 10% weight of a wetting agent to the portions of the copper seed layer.

Implementations may include one or more of the following features. The wetting agent can be an organic acid, such as citric acid, acetic acid, oxalic acid, formic acid or a combination thereof. The wet-etch formulation can comprise a strong inorganic acid and an oxidizing agent, such as hydrogen peroxide, for example hydrogen peroxide making up between 0.1% and 1.5% by weight of the solution. The strong inorganic acid can be sulfuric acid or hydrofluoric acid. The wet-etch formulation can contain sulfuric acid or hydrofluoric acid in the range 3.0-3.5% by weight and hydrogen peroxide in the range 0.6-0.7% by weight and the wetting agent is acetic acid or citric acid in the range 4.6-5.1% by weight. The wet-etch formulation can be ammonium persulfate, for example, in an amount of substantially 4 to 5% by

### BRIEF DESCRIPTION OF THE DRAWINGS

FIGS. 1-5 show schematics depicting structures obtained at various of a series of steps, indicating how compositions described herein may be deployed;

FIG. 6 shows a plan view of a substrate with a line;

FIGS. 7-13 show schematics depicting structures obtained at various of a series of steps for subtractive patterning of deposited Cu films for MIM and flat panel display Cu electrodes, indicating how compositions described herein may be deployed;

FIG. 14 shows a plan view of a substrate with a line;

FIG. 15 shows a schematic of device with a Cu seed layer;

FIG. 16 shows a schematic of an array of a substrate etched using a conventional solution;

FIG. 17 shows a schematic of an array of a substrate etched using a solution described herein;

FIG. 18 shows a side view of a line on a substrate that has been treated using a conventional solution;

FIGS. 19 and 20 show cross-sectional views of lines on substrates that have been etched using conventional and solutions described herein, respectively;

FIG. 21 shows a sheet resistance graph.

### DETAILED DESCRIPTION

Advantages of the compositions and methods described herein over current approaches in the art can include: no need for higher CD bias; no need to plate Cu much higher than the required target; the Cu line profile or shape (top CD, bottom CD) is substantially perfect (in other words, the same as defined by the resist profile), or near-perfect; removal of Cu seed in the open areas and in-between intricate circuit structures efficiently and uniformly with no undercut, with no damage to the Cu profile, and with no trace of Cu residue in the field or in between the intricate Cu structures.

Benefits of the compositions and methods described herein can include controlled etch rate and uniformity, especially for intricate and/or smaller dimensioned copper parts; and the ability to create parts with known or desired thicknesses. Compositions that etch copper at a rate that is too high are less easily controllable than those where the rate is lower, typically less than 5,000 Å per minute. The compositions described herein are suitable for use with components with critical dimensions as small as 0.2 μm in width and with spaces as small as 0.5 μm.

It is also desirable that the compositions described herein are stable over time. By this is meant that they give uniform results and only need to be tested for stability, for example, 2-3 times per week. Such variations as would be undesirable include deterioration of an oxidizing agent such as a peroxide, or variations in concentration of other components.

### Compositions

The compositions described herein are particularly useful for copper wet etch processes used in, for example, the through-mask method of copper deposition in the manufacture of semiconductor devices. They may also find use in the fabrication of high Q planar MIM (metal-insulator-metal) where highly conductive thin Cu plate is desired; or in the fabrication of electrodes for flat panel displays by subtractive patterning of deposited Cu films. The compositions described herein may further find use as agents for chemical mechanical polishing, as are deployed in planarization during a damascene, or dual-damascene, process.

Compositions described herein use a wetting agent in conjunction with wet-etch compositions that are proven to etch copper. Suitable wetting agents include acetic acid, citric acid, and organic acids containing the —COOH group.

In one implementation, a composition comprises a combination of an etch formulation and a wetting agent, together in aqueous solution. Preferably the etch formulation is one that is suitable for etching copper. In another implementation, the composition consists of an etch formulation and a wetting agent, together in aqueous solution; in still another implementation, the composition consists essentially of an etch formulation and a wetting agent together in aqueous solution. In yet another implementation, the composition comprises an aqueous solution of an oxidizing agent and a wetting agent.

In some implementations, an etch formulation for use with the composition comprises a strong inorganic acid and an oxidizing agent. In other implementations, the etch formulation consists essentially of a strong inorganic acid and an oxidizing agent. In still other implementations, the etch formulation consists of a strong inorganic acid and an oxidizing agent. The strong inorganic acid can be sulfuric acid (H₂SO₄) or hydrofluoric acid (HF). The oxidizing agent is can be a peroxide (e.g., hydrogen peroxide) or a peroxy acid. The oxidizing agent oxidizes a copper surface and facilitates etching. Thus, when used in the methods described herein, this etch formulation leads to a composition having a strong inorganic acid, an oxidizing agent, and a wetting agent.

In particular, it is a feature of the compositions herein that levels (weight %) of oxidizing agent are significantly lower, in comparison to those of strong acid, than are typically found in the art, but that levels of wetting agent are somewhat comparable to those of the strong acid.

Another etch formulation for use with the composition described herein is ammonium persulfate ((NH₄)₂S₂O₈). Thus, when used in the methods described herein, this etch formulation leads to a composition having ammonium persulfate, and a wetting agent.

The wetting agent for use in the compositions described herein is preferably an organic acid, and may also include mixtures of one or more organic acids. Exemplary organic acids are acetic acid, citric acid, oxalic acid, and formic acid, though many others are possible.

For example, still other organic acids that may be used as a wetting agent in compositions described herein include, but are not limited to: acetoacetic; acrylic; adipic; ascorbic; benzoic; benzosulfonic; bromoacetic; butyric; iso-butyric; chloroacetic; cis- or trans-cinnamic; phenylacetic; o-, m-, or p-chlorophenylacetic; o-, m-, or p-cresol; crotonic; cyanoacetic; cyclohexane-1:1-dicarboxylic; dichloroacetic; dinitrophenol; fumaric; furancarboxylic; gallic; glutaric; heptanoic; hexanoic; o-, m-, or p-hydroxybenzoic; iodoacetic; lactic; maleic; malic; malonic; naphthalenesulfonic; o-, m-, or p-nitrobenzoic; octanoic; dodecanoic; phenylacetic; phenylbenzoic; o-, m-, or p-phthalic; picric; pimelic; iso-propylbenzoic; quinolinic; succinic; sulfanilic; tartaric; meso-tartaric; thioacetic; o-, m-, or p-toluic; trichloroacetic; trichlorophenol; trimethylacetic; uric; n-valeric; iso-valeric; and vinylacetic.

Further categories of organic acids that may behave as wetting agents in the proposed compositions include organic acids having up to and including three carboxylic acid (—COOH) groups and 24 carbon atoms or fewer. Such organic acids may include compounds commonly referred to as surfactants. In one implementation, the wetting agents are organic acids having up to and including three —COOH groups and 12 carbon atoms or fewer. In another implementation, the wetting agents are organic acids having up to and including three —COOH groups and 6 carbon atoms or fewer.

It is still further consistent with the compositions and methods described herein that the organic acids include so-called ‘vinylogous’ carboxylic acids, i.e., those acids having one or more carbon-carbon double bonds conjugated with one another and with a carbonyl group such that at least one conjugated carbon-carbon double bond lies between the carbonyl group and a carbon atom bearing a vinyl hydroxyl group. Such acids include 3,4-dihydroxy-3-cyclobutene-1,2-dione (squaric acid); 2,5-dihydroxy-1,4-benzoquinone; 4,5-dihydroxy-4-cyclopentene-1,2,3-trione (croconic acid); 2-hydroxy-2,4,6-cycloheptatrienone (tropolone); and 6-hydroxy-1-tetralone and 5,5-dimethyl-1,3-cyclohexanedione (dimedone).

Still other groups may be present in organic molecules that confer acidity upon them, and give rise to organic acids that are compatible with the compositions described herein: for example, sulfonic acid groups, or hydroxyl groups in conjunction with strong electron-withdrawing agents. Such groups may therefore be present in conjunction with the aliphatic and aromatic carbon skeletons previously or subsequently referred to herein.

The carbon atoms of the organic acids may be found in aliphatic, aromatic, or in a combination of aliphatic and aromatic environments. Thus, the organic acids may have straight or branched chain carbon-containing groups or cyclic groups, and such groups are preferably ‘saturated’, i.e., composed of single bonds between carbon atoms and between carbon and other atoms, but may contain one or more double or triple bonds. The organic acids may contain one or more aromatic ‘nuclei’, such as benzene, naphthalene, phenanthrene, and anthracene. Such aromatic groups may have one or more straight or branched-chain carbon groups attached to them.

The organic acids may further contain one or more heteroatom substituents, bonded to carbon atoms therein. For example, halogenated, e.g., chloro, fluoro, and bromo, acids are consistent with the compositions described herein. The heteroatoms may also be present in heteroaromatic moieties such as pyrrole or furan that are themselves substituted with aliphatic, or acidic functionalities.

Preferably the organic acid that is used as a wetting agent is a weaker acid (i.e., has a higher pKa) than the strong inorganic acid of the etch formulations described herein. Thus, the organic acid wetting agent for use in the compositions described herein preferably has a pKa in the range 10⁻¹ to 10⁻⁶, such as a pKa in the range 10⁻² to 10⁻⁵, or a pKa in the range 10⁻³ to 10⁻⁴.

The organic acid wetting agent used with the compositions herein may be monobasic, or polybasic, such as dibasic, or tribasic. Examples of monobasic organic acids include formic acid, acetic acid, and benzoic acid. Examples of dibasic organic acids include oxalic acid, succinic acid, and phthalic acid. Examples of tribasic organic acids include citric acid. For polybasic organic acids, it is consistent with the compositions described herein that the pKa of the first dissociation is in the range 10⁻¹ to 10⁻⁶.

Preferred compositions of the wet etching agents of the compositions described herein include, but are not limited to, wetting agents in the ranges 3-10% by weight, 4-9% by weight, 4.5-8% by weight, 5.0-7.0% by weight, 5.0-6.0% by weight, 4.6-5.1% by weight, 4.7-5.0% by weight, and 4.8-4.9% by weight. It is to be understood that the various upper and lower endpoints of the foregoing ranges may be interchanged without limitation: for example, although not specifically recited in the foregoing, a range of 5.0-10% by weight is also considered within the scope of the present invention, as is a range of 3-5.1% by weight.

Other compositions containing strong inorganic acids as further described herein include, but are not limited to, strong acids in the ranges 2.5-4.0% by weight, 2.6-3.9% by weight, 2.7-3.8% by weight, 2.8-3.7% by weight, 2.9-3.6% by weight or 3.0 to 3.5% by weight. It is to be understood that the various upper and lower endpoints of the foregoing ranges may be interchanged with one another without limitation: for example, although not specifically recited hereinabove, a range of 2.5-3.9% by weight is also considered within the scope of the present invention, as is a range of 2.6-3.7% by weight.

The strong inorganic acids can be present in amounts less than 2%, such as less than 1% by weight. Accordingly, etching solutions can include trace amounts of strong inorganic acids such as 0.01% by weight, 0.1% by weight, between 0.1% and 0.2% by weight, 0.2-0.5% by weight, and 0.6-0.9% by weight, and any range overlapping with the foregoing ranges up to and including 0.99% by weight.

Compositions as further described herein that contain the oxidizing agent hydrogen peroxide include, but are not limited to, hydrogen peroxide in the ranges 0.1-1.5% by weight; 0.2-1.4% by weight; 0.3-1.3% by weight; 0.4-1.2% by weight; 0.5-1.1% by weight; 0.6-1% by weight; 0.6-0.9% by weight; 0.7-0.9% by weight, and 0.6-0.8% by weight. It is to be understood that the various upper and lower endpoints of the foregoing ranges may be interchanged with one another without limitation: for example, although not specifically recited hereinabove, a range of 0.1-0.5% by weight is also considered within the scope of the present invention.

Thus, the wet-etch formulation suitable for etching copper is preferably present in, but is not limited to, the range 2.6-6% by weight.

All combinations of the foregoing components are also consistent with the compositions and methods described herein. Particular compositions are, as follows: those comprising 2.5-4.0% by weight strong inorganic acid, 0.1-1.5% by weight hydrogen peroxide, and 3-10% by weight wetting agent; those consisting essentially of 2.5-4.0% by weight strong inorganic acid, 0.1-1.5% by weight hydrogen peroxide, and 3-10% by weight wetting agent; and those consisting of 2.5-4.0% by weight strong inorganic acid, 0.1-1.5% by weight hydrogen peroxide, and 3-10% by weight wetting agent.

Still other compositions are: those comprising 3.0-3.5% by weight strong inorganic acid, 0.6-0.7% by weight hydrogen peroxide, and 4.6-5.1% by weight wetting agent; those consisting essentially of 3.0-3.5% by weight strong inorganic acid, 0.6-0.7% by weight hydrogen peroxide, and 4.6-5.1% by weight wetting agent; and those consisting of 3.0-3.5% by weight strong inorganic acid, 0.6-0.7% by weight hydrogen peroxide, and 4.6-5.1% by weight wetting agent.

The compositions described herein can contain ammonium persulfate, where the ammonium persulfate is present in small amounts, such as amount less than 2%, for example, amounts less than 1%. Accordingly, especially the proportions of ammonium sulfate can be trace amounts, such as 0.01% by weight, 0.1% by weight, between 0.1% and 0.2% by weight, 0.2-0.5% by weight, and 0.6-0.9% by weight, and any range overlapping with the foregoing ranges up to and including 0.99% by weight.

In some implementations of the compositions described herein, the aqueous portion of the solution consists solely of a wetting agent, a strong acid and optionally, the oxidizing agent. If the composition is used as a slurry for CMP, the slurry can optionally include abrasive particles, such as silica.

### Processes

Processes are described herein that deploy a composition as also described herein for efficiently removing residual copper materials in semiconductor processing. As such, the compositions described herein can be used in all manner of processes in which a layer of copper—typically in an intricate arrangement—is deposited and is subsequently refined, such as by etching away excess. Processes which benefit from the compositions described herein are particularly those in which excess copper is found in hard-to-reach areas that are more readily accessed by etching compositions that have a wetting agent. Additionally, the etching solutions described herein are ideal for etching at a rate of about 5,000 Å/minute or less. Intricate inductor structures, such as inductors having dimensions of 1 micron in width or even submicron dimensions can be etched using the etching solutions described herein.

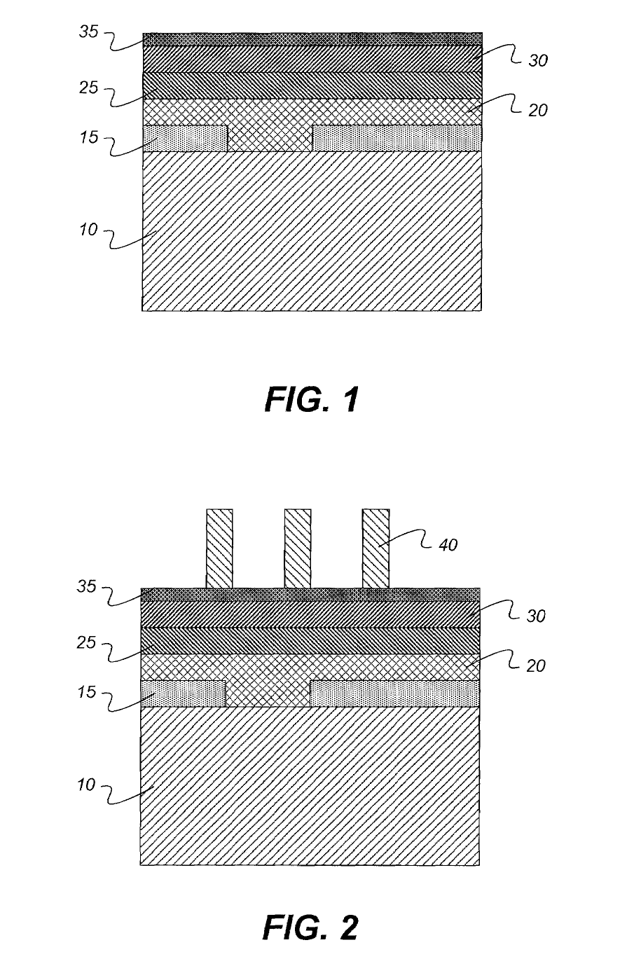

In one implementation, a process of using the foregoing compositions for removing Cu seed after through-mask electroplating of Cu interconnects is described. FIG. 1 shows a sequence of snap-shots of structures at various stages in such a process.

Referring to FIG. 1, on a substrate 10 are a conductive interconnect 15, formed of aluminum or copper, with a first passivation layer 20 and a second passivation layer 25 thereon. The passivation layers 20, 25 are formed of a dielectric material, such as SiON, Si₃N₄, or SiO₂, or a combination thereof. A Cu barrier 30 is deposited on the second passivation layer 25, followed by a Cu seed 35. Referring to FIG. 2, photoresist structures 40 are deposited by lithography, which may include a sequence of spin-coating, exposing, and developing steps. The device is optionally ‘de-scummed’ (i.e., residual photoresist on Cu is removed), for example with an O₂ plasma etch.

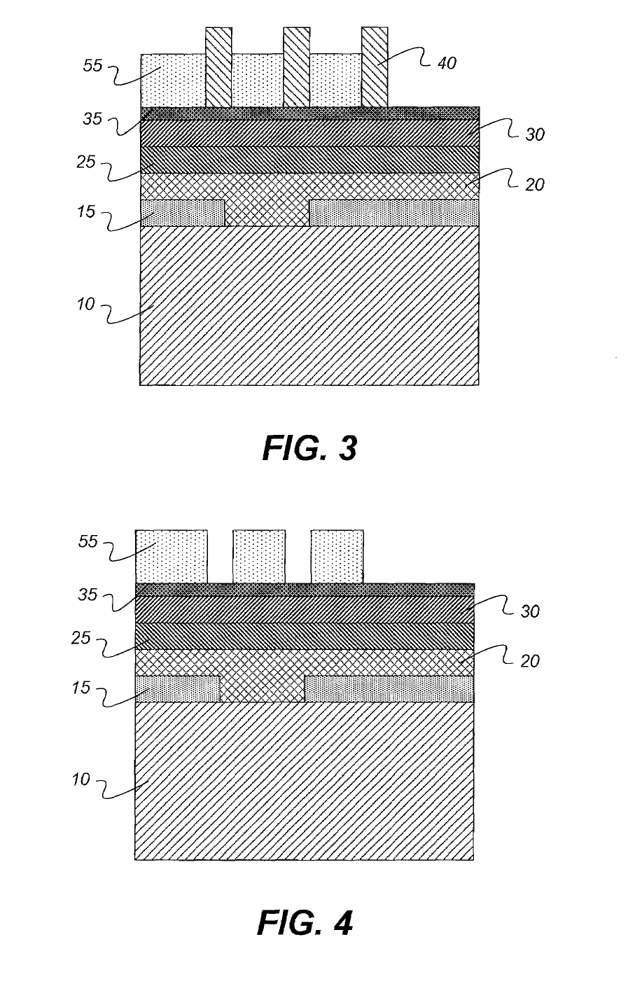

Referring to FIG. 3, copper interconnects 55 are deposited, for example by electroplating, in between the photoresist structures 40. Referring to FIG. 4, the photoresist structures 40 are removed by, e.g., wet-stripping and cleaning, and the copper interconnects 55 are annealed to transform the plated Cu and Cu seed into one continuous Cu material through thermal induced grain re-growth. This will further reduce the probability of undercut since the Cu seed under the plated Cu is now morphologically different from Cu seed in the field area.

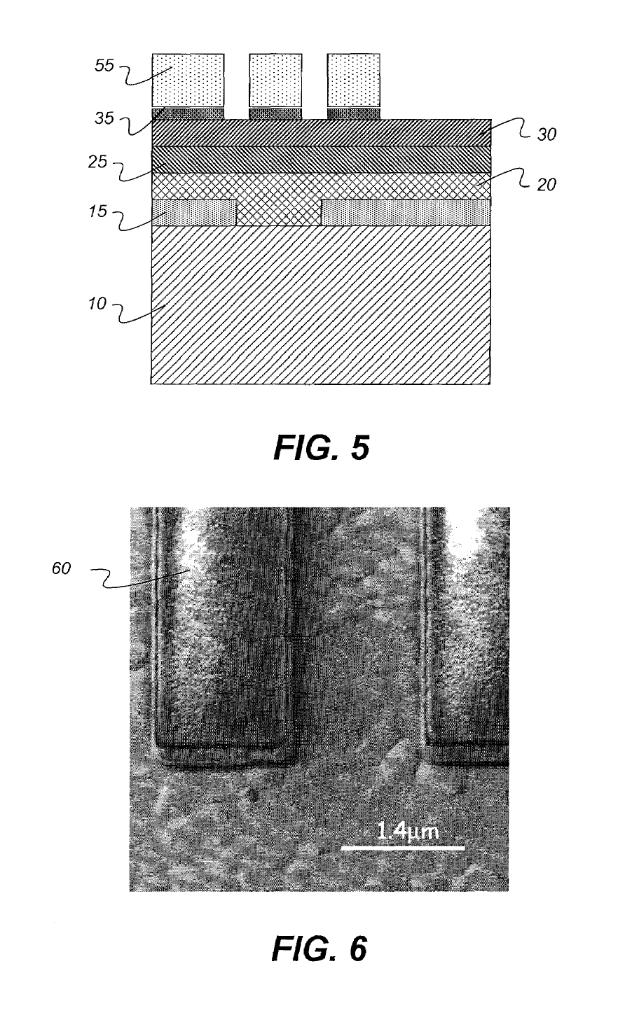

Referring to FIG. 5, the compositions described herein are applied to remove Cu seed 35 layers outside of the Cu interconnects 55. Existing chemistries in the art etch the Cu seed in the field area at a faster rate than the Cu seed in between the Cu lines, which forces a much longer etch time that itself leads to Cu line undercut and Cu structure profile destruction. By contrast, the compositions described herein etch the Cu seed in the field area and in between the Cu lines at more or less the same rate, due to their better wetting abilities. Thus, the compositions described herein provide a much larger process window, with no penalties for the integrity of the device. Although a shorter time is typically utilized to clear the undesired Cu, the etch time could be deliberately made longer to make absolutely sure that the Cu is cleared without damaging the desired feature.

FIG. 6 shows a plan view of Cu lines 60 formed using the etching solutions described herein. The lines are shown after a Cu wet etch and Cu barrier dry etch. The lines 60 have a width of less than 1.5 μm and are able to form lines with very linear dimensions.

It would be understood that the compositions described herein could be deployed in chemical mechanical polishing applications in a similar manner to their deployment in wet-etching described herein.

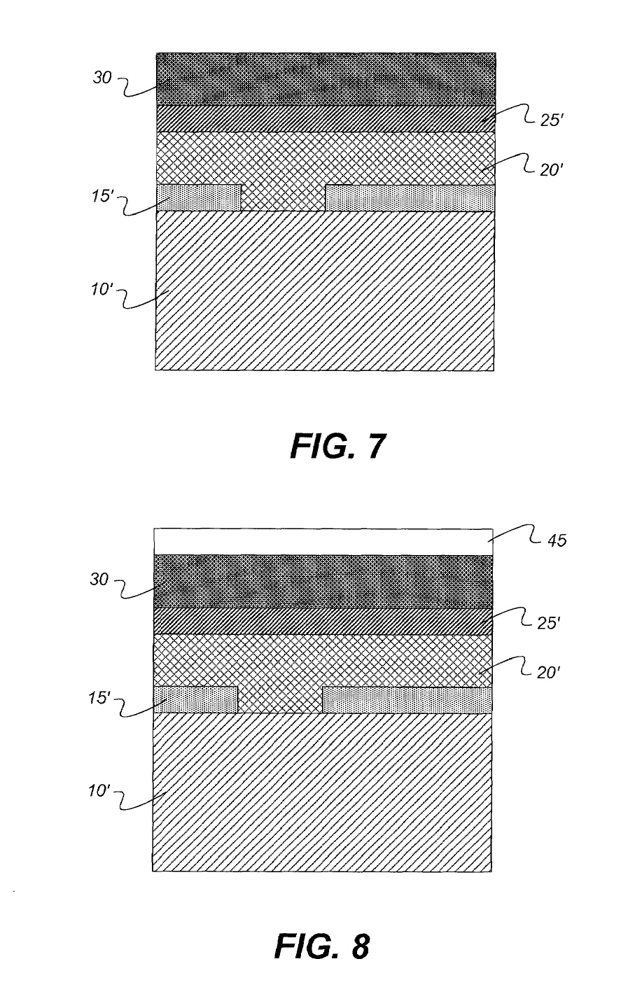

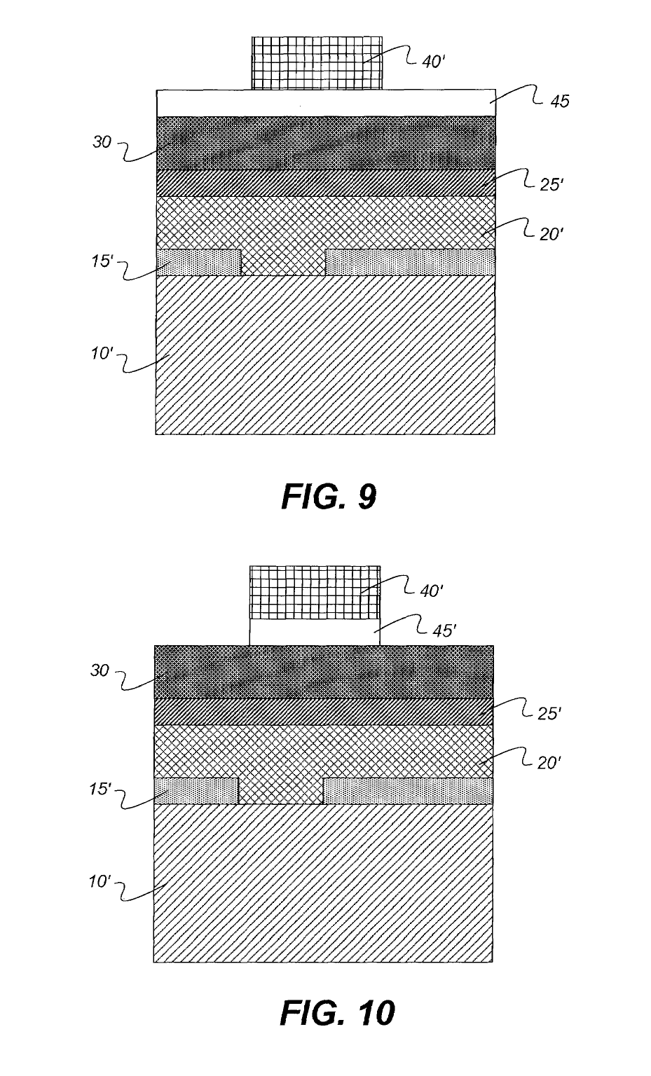

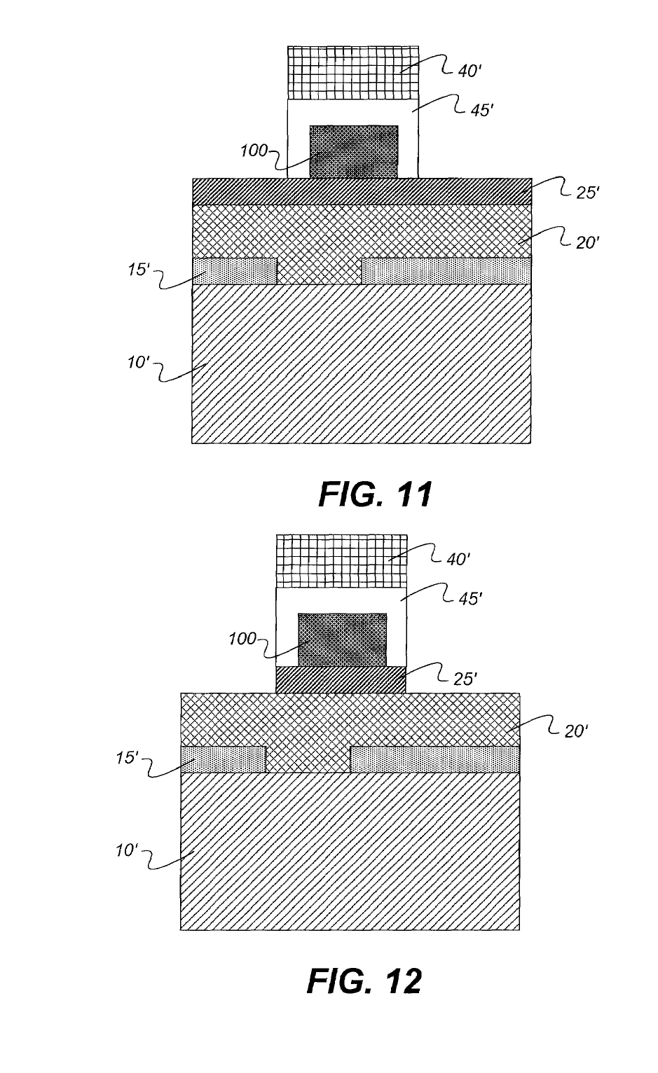

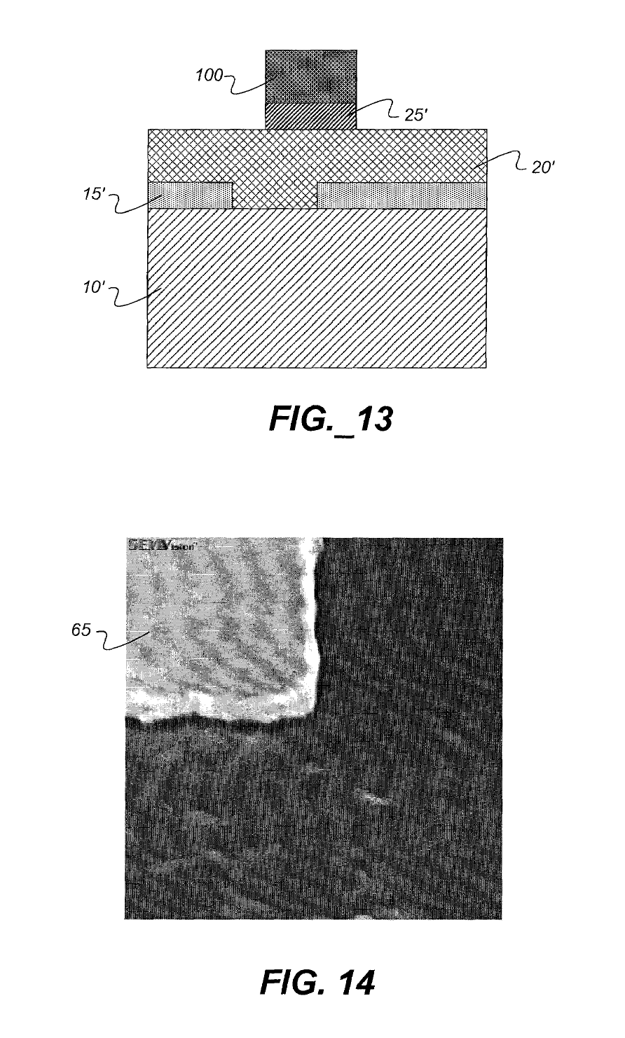

It would further be understood that the compositions described herein could be deployed for subtractive patterning of deposited Cu films for MIM and flat panel display Cu electrodes. As shown in FIG. 7, a substrate 10′ is shown with a Cu thin film 30 (e.g., physical vapor deposited) on a Cu barrier 25′, which itself is on, in turn, a passivation dielectric 20′, an interconnect 15′ and the substrate 10′. As shown in FIG. 8, a 200 to 1,000 Å thick capping layer of SiN 45′ is deposited on the Cu thin film 30. As shown in FIG. 9, areas of photoresist 40′ are deposited on the SiN capping layer 45′. As shown in FIGS. 10 and 11, respectively, SiN outside of the photoresist 40′ is etched away (e.g., by dry etching), and a Cu wet etch is applied to exposed Cu thin film 30′ using compositions described herein. The Cu wet etch composition provides an isotropically controlled Cu wet etch. Furthermore, as soon as the Cu thin film 30 is able to expose the Cu barrier 25′, the SiN layer collapses to protect the desired Cu line 100 formed from residual of thin film 30. This approach allows Cu feature definition with lateral size about the thickness of the Cu film. As shown in FIG. 12, the remaining Cu barrier 25′ is removed by dry or wet etch, and in FIG. 13, the photoresist 40′ has been stripped, and the sacrificial SiN 45′ has been etched away.

In FIG. 14, a plan view is shown of a Cu line 65 formed using the etching compositions described herein. The line 65 is shown after a Cu wet etch, Cu barrier dry etch, photoresist strip, and SiN cap layer etch have been carried out.

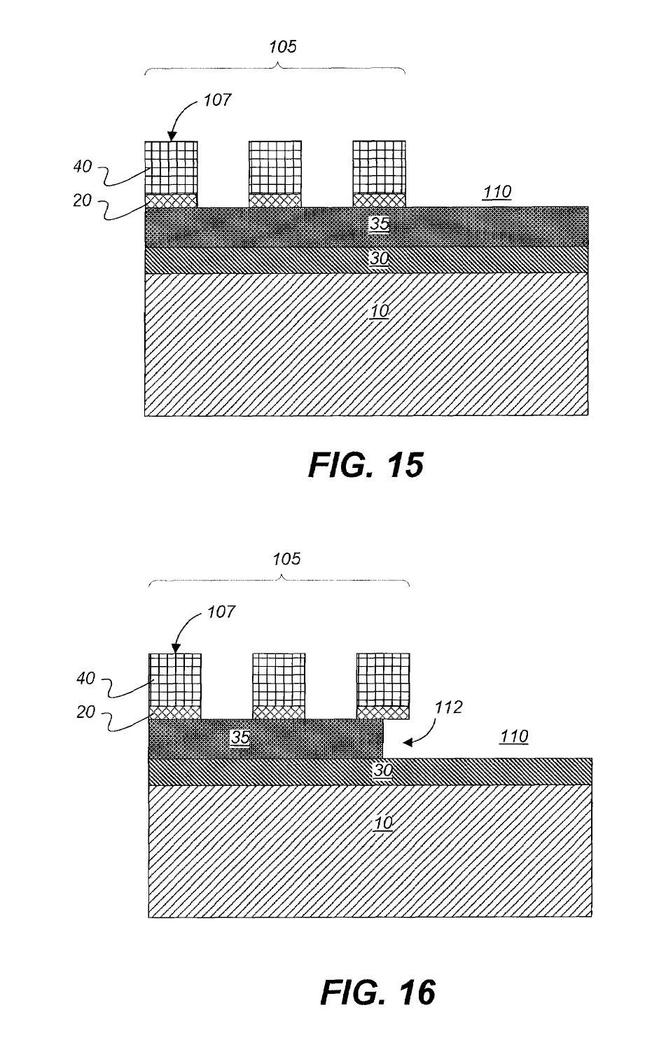

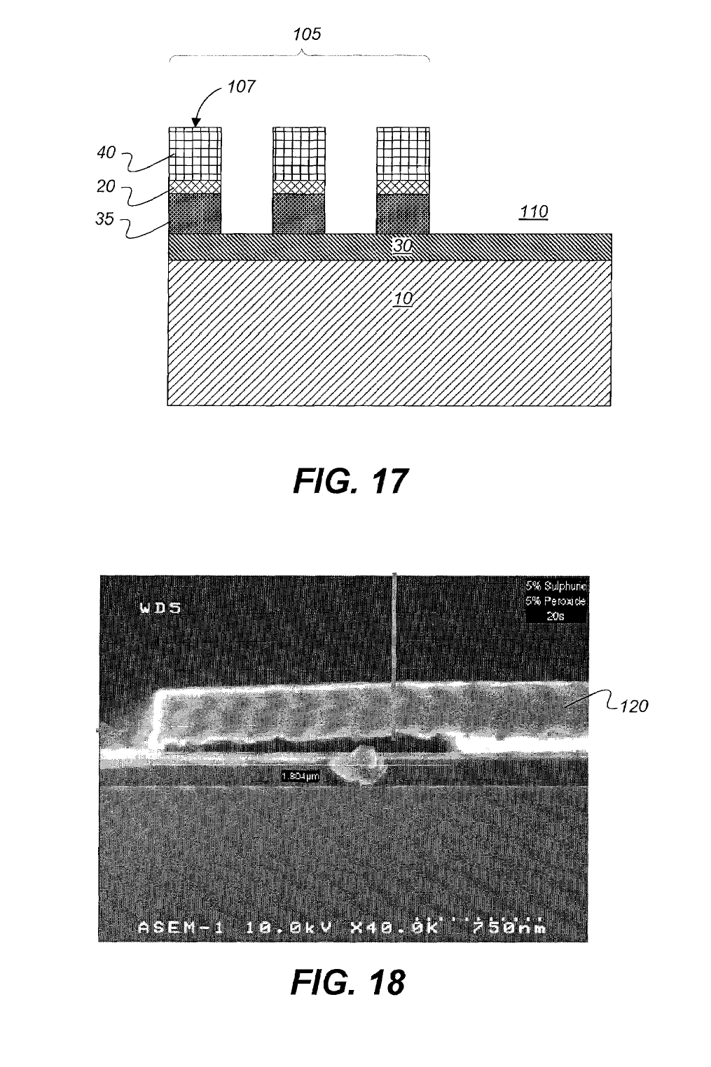

Referring to FIGS. 16 and 17, a comparison of Cu wet etch performance is shown between existing chemistry and the formulations described herein, on an incoming device shown in FIG. 15. Cu seed 35 has a thickness of 1200 Å. The Cu barrier layer 30 is a 300 Å thick layer of tantalum. Dielectric 20 is a 300 Å thick layer of SiN. The comparison is for etches carried out for the same duration, and demonstrates that there is much uncleared copper seed 35 between the Cu inductor lines 107 after application of an existing chemistry. In FIG. 16, the existing chemistry of 5% H₂SO₄ and 5% H₂O₂ applied for 20 seconds has not fully etched Cu seed 35 from between the inductor lines 107 in the array 105, even when the Cu has been cleared from the field 110. Further, there is undercutting in area 112. In FIG. 17, one of the formulations described herein, 5% H₂SO₄, 5% H₂O₂ and 4% acetic acid, has cleared the Cu seed 35 from between the inductor lines 107 in the array 105.

FIG. 18 is a micrograph of a side view of a copper coil that has been etched using an existing chemistry, consisting of a 5% H₂SO₄ and 5% H₂O₂ solution, applied for 20 seconds. The wire 120 at the exterior of the array is heavily undercut and lifts off of the substrate. Such undercutting can be prevented by etching with one of the solutions described herein.

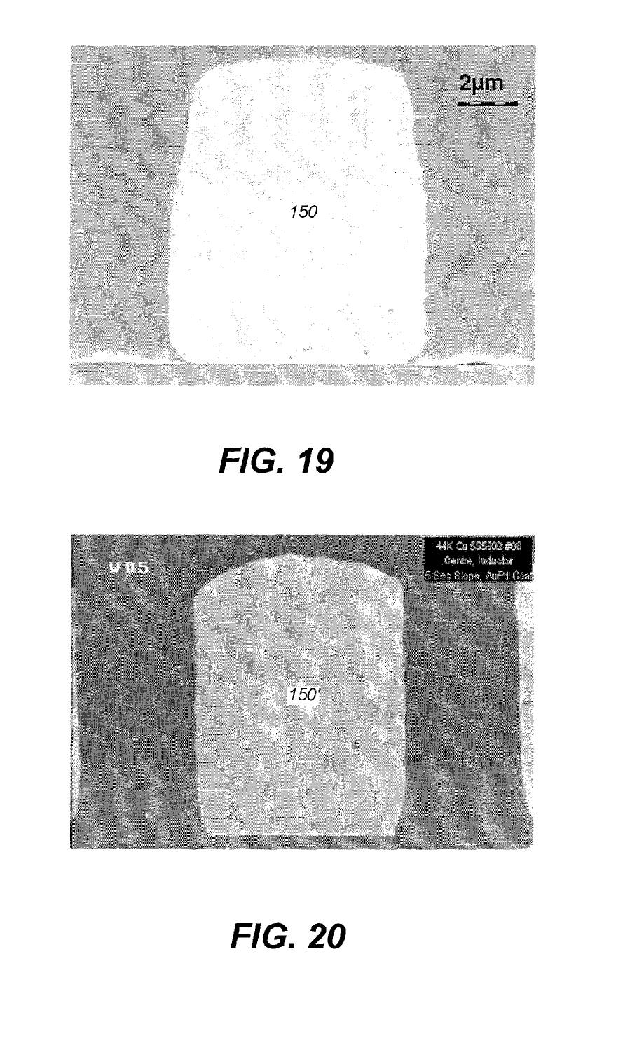

FIGS. 19 and 20 show cross-sectional views of a Cu inductor device, such as the device schematically shown in FIG. 5, processed by, respectively, an optimized conventional etching solution (FIG. 19), and a formulation described herein (FIG. 20). A line 150 from a substrate that has been etched by a conventional solution exhibits more undercutting and non-linear deformation of its side walls (FIG. 19) than a line 150′ that has been etched using a solution described herein (FIG. 20). The line 150′ that has been etched using a solution described herein has greater uniformity with respect to width from the bottom of line 150′ (bottom of the figure) to the top of the line 150′ (top of the figure).

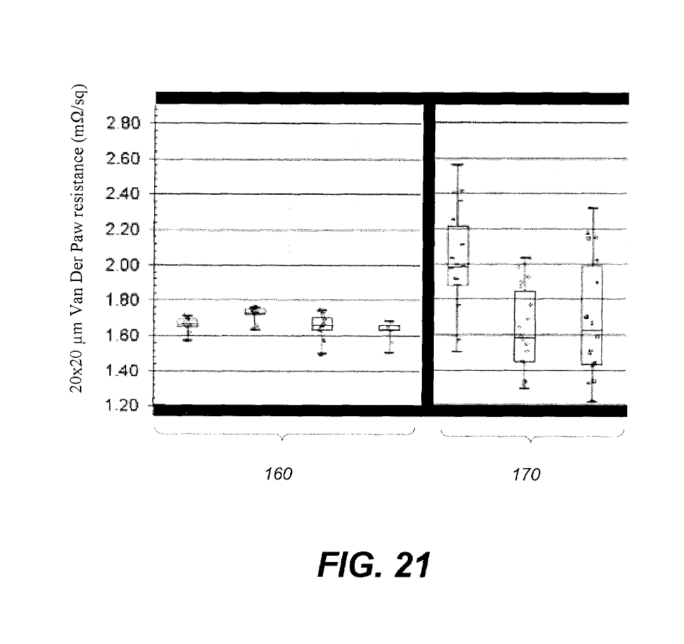

Referring to FIG. 21, because of the enhanced etching characteristics of the solutions described herein, the copper profile and consequently the sheet resistance is significantly improved. A substrate having Cu lines that has been etched using a formulation in the art has resistance characteristics that vary widely, as shown in graph 170. On a substrate having Cu lines that has been etched using a solution as described herein, there are much narrower ranges of resistance, as shown in graph 160. The sheet resistance data is measured from 20*20 μm Van der Pauw structures. The Cu thickness and profile vary more when etched with an existing chemistry than with the solutions described herein. The superior control of sheet resistance in graph 160 is attributed to the improved etch behavior of the solutions described herein. Etching using the solutions results in minimal thickness and CD loss of the copper structure.

### EXAMPLES

### Example 1

### Preferred Compositions Having a Strong Inorganic Acid, Hydrogen Peroxide, and a Wetting Agent

| Component | % w/w |
|---|---|
| Wetting agent (e.g., acetic acid, citric acid) | 4.6–5.1 |
| Inorganic acid (e.g., H₂SO₄ or HF) | 3.0–3.5 |
| Hydrogen peroxide | 0.6–0.7 |
| Water | Balance |

### Example 2

### Preferred Compositions Having Ammonium Persulfate and Wetting Agent

| Component | % w/w |
|---|---|
| Wetting agent (e.g., acetic acid, citric acid, etc.) | 4.6–5.1 |
| Ammonium persulfate | 4.0–5.0 |
| Water | Balance |

The above formulations are exemplary, and can be varied according to specific needs and requirements, such that the component concentrations can be increased or decreased beyond the above-specified levels. For example, the concentration of the wetting agent can be adjusted according to the intricacy of the device structures. To etch more intricate device structures, one would use an increased amount of the wetting agent, especially for penetrating into the corners of the structure. In another example, if a faster etch rate is desired, then one could increase the concentration of hydrogen peroxide.

The foregoing description is intended to illustrate various aspects of the present invention. It is not intended that the examples presented herein limit the scope of the present invention. The invention now being fully described, it will be apparent to one of ordinary skill in the art that many changes and modifications can be made thereto without departing from the spirit or scope of the appended claims.

What is claimed:

1. A composition comprising an aqueous solution of:
2.6 to 6% by weight of a wet-etch formulation that is proven to etch copper; and
3 to 10% weight of a wetting agent.

2. The composition of claim 1, wherein the wetting agent is an organic acid.

3. The composition of claim 2, wherein the organic acid is selected from the group consisting of: citric acid, acetic acid, oxalic acid, and formic acid.

4. The composition of claim 1, wherein
the wet-etch formulation comprises a strong inorganic acid and an oxidizing agent.

5. The composition of claim 4, wherein the oxidizing agent is hydrogen peroxide.

6. The composition of claim 5, wherein the hydrogen peroxide makes up between 0.1% and 1.5% by weight of the solution.

7. The composition of claim 4, wherein the strong inorganic acid is sulfuric acid or hydrofluoric acid.

8. The composition of claim 1, wherein the wet-etch formulation is ammonium persulfate.

9. The composition of claim 8, wherein the solution comprises 4 to 5% by weight ammonium persulfate.

10. The composition of claim 1, wherein:
the wet-etch formulation contains sulfuric acid or hydrofluoric acid in the range 3.0-3.5% by weight, and hydrogen peroxide in the range 0.6-0.7% by weight; and
the wetting agent is acetic acid or citric acid in the range 4.6-5.1% by weight.

11. A composition consisting essentially of an aqueous solution of:
2.6 to 6% weight of a wet-etch formulation that is proven to etch copper; and
0.6 to 10% by weight of a wetting agent selected from the group consisting of: citric acid, acetic acid, oxalic acid, and formic acid.

12. A composition consisting of an aqueous solution of:
2.6 to 6% weight of a wet-etch formulation that is proven to etch copper; and
0.6 to 10% by weight of a wetting agent selected from the group consisting of: citric acid, acetic acid, oxalic acid, and formic acid.

13. A method of wet-etching copper conductors comprising:
applying an aqueous etching solution to a surface comprising copper, wherein the aqueous etching solution comprises 2.6 to 6% weight of a wet-etch formulation that is proven to etch copper, and 0.6 to 10% weight of a wetting agent.

14. A method of fabricating a copper inductor, comprising:
forming a copper seed layer on a substrate;
forming a mask on the seed layer;
applying a layer of copper to form an array of copper interconnects;
removing portions of the copper seed layer from between the copper interconnects, wherein the removing step comprises applying an aqueous etching solution to a surface comprising copper, wherein the aqueous etching solution comprises 2.6 to 6% weight of a wet-etch formulation that is proven to etch copper, and 0.6 to 10% weight of a wetting agent to the portions of the copper seed layer.
